(19) United States
(12) Patent Application Publication
(10) Pub. No.: US 2007/0130106 A1
(43) Pub. Date: Jun. 7, 2007

(54) System and method for protecting data in a database

(75) Inventor: Kishore Gadiraju, Sunnyvale, CA (US)

Correspondence Address: William L. Botjer, P.O. Box 478, Center Moriches, NY, 11934, US

(73) Assignee: SOLIX, INC.

(21) Appl. No.: 11/291,380

(22) Filed: Dec. 1, 2005

(51) Int. Cl. G06F 17/30

(52) U.S. Cl. 707/2

(57) ABSTRACT

A system and method for protecting data stored in a database, such as a non-production database is provided. The database comprises a plurality of data sets, wherein each data set comprises a plurality of data parts. At least one of the plurality of data sets is related to at least one of the plurality of the other data sets. The system comprises a data selecting module for selecting data from the database. The data selecting module enables the selection of at least one data part upon selection of a first data part. The at least one data part is related to the first data part. The at least one data part and the first data part exist in separate datasets. The system includes a masking module for masking the selected data.

### RELATED APPLICATION

This application is related to the following application which is hereby incorporated by reference as if set forth in full in this specification: Co-pending U.S. patent application Ser. No. 11/274,558, entitled ‘System and Method for Managing Data in a Database’, filed on Nov. 15, 2005.

### BACKGROUND OF THE INVENTION

The present invention relates to databases. More specifically, the present invention relates to a system and method for protecting data in relational database.

Application programs built upon a relational database such as Online Transaction Processing (OLTP) systems are used in industries in the areas of product planning, parts purchasing, maintaining inventories, supplier interaction, customer service, and tracking.

Throughout an application lifecycle, testing activities occur to test and validate various aspects of the working of the application. The testing activities usually occur in a non production database such as a test database or a development database. Often the data that has to be tested has to be protected as the data may contain confidential or sensitive information. Applying masking techniques, such as substrings, arithmetic expressions, random or sequential number generation can be used to protect the data in the database. The masking operation should be such that the data can no longer be used to identify an individual. Other methods such as physical access controls or network security may also deny access to the application. While these measures provide some degree of access control, they may not be sufficient for testing.

Deploying cost effective proven solutions that enable de-identifying the data in the test databases is therefore essential to privacy compliance. Moreover, it is essential that referentially intact subsets are extracted form the production database to the non-production database. Further the data after masking should allow accurate and reliable testing. Since the database in the non-production database is relational, it is also essential all related data is efficiently selected and masked, i.e. the process of selection of the data to be masked should also be made customizable and user-friendly

### SUMMARY OF THE INVENTION

An objective of the invention is to protect data in a database, such as a non-production database.

A system and method for protecting data stored in the database is provided. The database comprises a plurality of data sets, wherein each data set comprises a plurality of data parts. At least one of the data sets is related to at least one of the other data sets.

The system comprises a data selecting module for selecting data from the database. The data selecting module enables the selection of at least one data part upon selection of a first data part. The at least one data part is related to the first data part. Further, the at least one data part and the first data part exist in separate datasets. Additionally, the system includes a masking module for masking the selected data.

The method includes selecting a first data part from at least one data set. The method further includes selecting at least one data part from a data set related to the at least one data set. In addition, the method includes masking the first data part and the at least one data part.

The present invention enables protecting a data part and all the related data parts of the data part simultaneously using a single masking rule. The simultaneous masking of all the related data parts ensures that the data parts are robustly masked. Further, the data parts can be simultaneously de-masked using a corresponding de-masking rule.

### BRIEF DESCRIPTION OF THE DRAWINGS

The various embodiments of the invention will hereinafter be described in conjunction with the appended drawings provided to illustrate and not to limit the invention, wherein like designations denote like elements, and in which:

FIG. 1 is a block diagram illustrating an exemplary database, in accordance with an embodiment of the invention;

FIG. 2 is an exemplary relational database, in accordance with an embodiment of the invention;

FIG. 3 illustrates a system for protecting data in a database, in accordance with an embodiment of the invention;

FIG. 4 is an exemplary block diagram of a Graphical User Interface (GUI) screen for selecting data for protection, in accordance with various embodiments of the invention; and

FIG. 5 is a flowchart depicting a method for protecting data in a database, in accordance with an embodiment of the invention.

### DESCRIPTION OF PREFERRED EMBODIMENTS

Before describing in detail a system and a method for protecting data in a database such as a relational database, in accordance with the present invention, it should be observed that the present invention resides primarily in combinations of method steps and apparatus components related to a configuration engine. A more detailed description of the configuration engine is provided in a commonly owned co-pending U.S. patent application Ser. No. 11/274,558 entitled ‘System and Method for Managing Data in a Database’, filed on Nov. 15, 2005. Accordingly, the apparatus components and method steps have been represented, where appropriate, by conventional symbols in the drawings. These drawings show only the specific details that are pertinent for understanding the present invention, so as not to obscure the disclosure with details that will be apparent to those with ordinary skill in the art and the benefit of the description herein.

Various embodiments of the present invention provide a system and a method for protecting data stored in a database such as a non-production database. The non-production database is a relational database which includes related datasets. The protection of the data is achieved by masking a set of datasets. The system allows selection of related data parts in the related datasets and enables applying a single masking rule to all the related data parts. The masking may be performed using predefined methods or known methods available in the art.

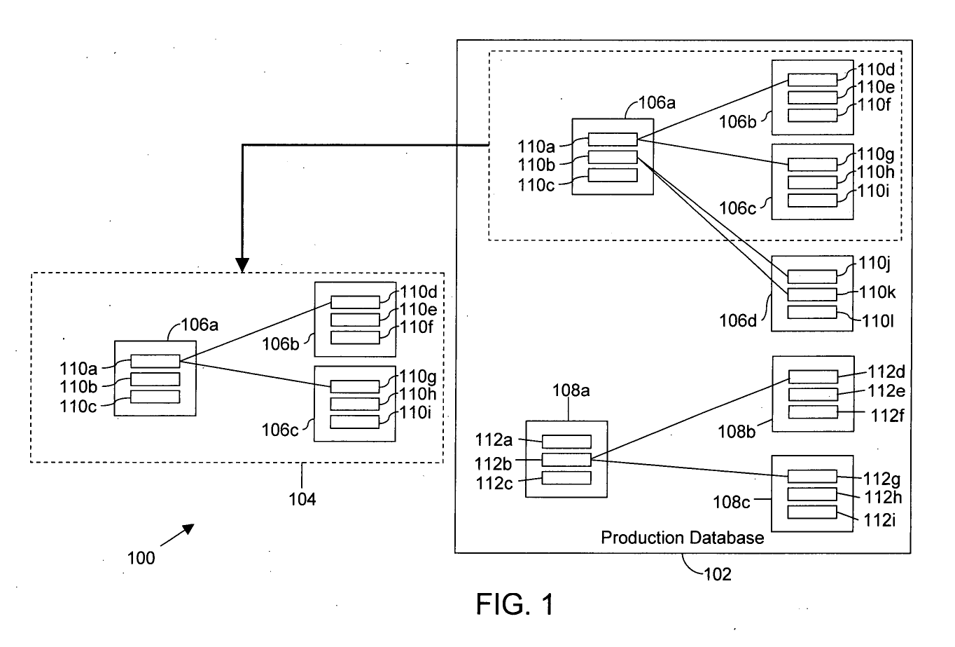

FIG. 1 is a block diagram illustrating an exemplary database 100, in accordance with an embodiment of the invention. Database 100 includes relational databases such as a production database 102 and a non-production database, such as test database 104. In an embodiment, production database 102 is a database that is used in conjunction with applications involved in the processing of transactions related to businesses such as, for example, banking, airlines, mail order, supermarkets, and manufacturers. An example of such an application is an Online Transaction processing systems (OLTP) that may be used for electronic banking or order processing.

In various embodiments, production database 102 includes multiple data sets wherein each data set includes multiple data parts. In an embodiment, a data set is a data structure which may be exemplified in the form of a table. The data parts in each of the data sets may be exemplified in the form of columns. Production database 102 is structured such that at least one of the data sets present is related to at least one of the other data sets. In an embodiment, test database 104 stores a subset of production database 102 and is used for performing test activities. The subset according to the present invention may be created from any known method known in the art.

Production database 102 includes a plurality of data sets 106a to 106d (hereinafter referred to as datasets 106), and a plurality of datasets 108a to 108c (also referred to as datasets 108). Each of data sets 106 includes a plurality of data parts 110, while each of datasets 108 includes a plurality of datasets 112. Data set 106a includes data parts 110a to 110c. Similarly, data set 106b includes data parts 110d to 110f, data set 106c includes data parts 110g to 110i, and dataset 106d includes data parts 110j to 110l. Similarly, dataset 108a includes data parts 112a to 112c, dataset 108b includes data parts 112d to 112f and dataset 108c includes data parts 112g to 112i.

In various embodiments, the datasets present in production database 102 are available only after the datasets are registered with a knowledgebase that is used in conjunction with the configuration engine referenced in this application. For instance, the datasets may be selected from source database(s) that are part of an Enterprise Resource Planning (ERP) system. The knowledgebase stores the names of the registered datasets as well as the relationship between them. Therefore the knowledgebase ensures the referential integrity of the datasets present in production database 102.

Data sets 106 are related to each other through corresponding data parts. For example, in production database 102, data part 110a of data set 106a is related to data part 110d of data set 106b and data part 110g of data set 106c. Further, data part 110b is related to data parts 110j and 110k of data set 106d. Similarly, data part 112b is related to data part 112d and data part 112g.

Test database 104 includes data sets 106a to 106c, forming a subset having the same referential integrity as that of datasets 106a to 106c present in production database 102. It may be noted that test database 104 may also be comprised of the same datasets present in production database 102 i.e. test database 104 may be a replica of test database 102.

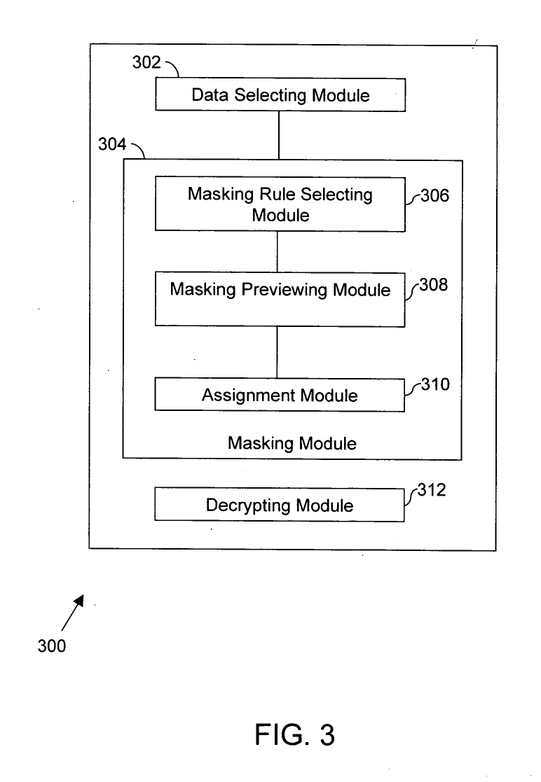

In an embodiment, the datasets stored in test database 104 are protected by the method described with reference to FIG. 3 to FIG. 5. In accordance with another embodiment, the datasets stored in production database 102 may also be protected in a similar manner. It may be apparent to a person skilled in the art that any datasets used in conjunction with an application may be protected using the above method.

In an embodiment, production database 102 may also store at least one dataset that is not related to any other dataset. The dataset may also be copied or replicated onto test database 104 and be suitably protected by methods described herein.

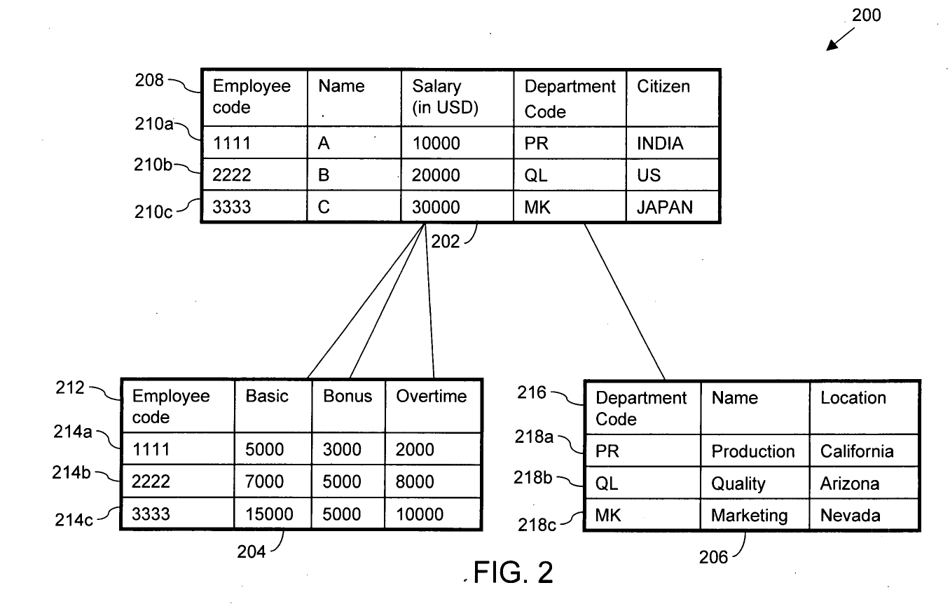

FIG. 2 is an exemplary relational database, in accordance with an embodiment of the invention. Database 200, which resides in a non-production database, such as a test or development database, includes a parent table 202 that is related to a child table 204 and a child table 206.

Parent table 202 includes bibliographic details of employees in a company. Child tables 204 and 206 include details pertaining to salaries and the departments of the employees, respectively. In an embodiment of the invention, parent table 202 is referred to as ‘DETAILS’, whereas child tables 204 and 206 may be referred to as ‘SAL’, and ‘DEPT’, respectively.

Parent table 202 includes rows 208, 210a, 210b, and 210c. Row 208 stores the names of the columns in accordance with the type of information provided. The columns include: ‘Employee Code’, ‘Name’, ‘Salary’, ‘Department Code’, and ‘Citizen’. The information in each of rows 210a, 210b and 210c may be referred to as a record and each record relates to a unique employee of the firm.

The column ‘Employee Code’ stores the employee code corresponding to an employee. Similarly, the column ‘Name’ stores the name of the employee, the column, ‘Salary’ stores the gross salary, the column ‘department code’ stores the department code for the employee and the column ‘citizen’ stores the citizenship of the employee. The employee code is also used as the Primary key (PK) for each record in child table 204 as it would be unique for each employee.

Child table 204 (SAL) includes information relating to the salary of the employees. Child table 204 includes rows 212, 214a, 214b, and 214c. Row 212 stores names of the columns—‘Employee Code’, ‘Basic’, ‘Bonus’, and ‘Overtime’. Each of rows 214a, 214b, and 214c stores the components of the salary of an employee whose information is stored in parent table 202. In child table 204, the column ‘Employee code’ stores the employee code. The employee code acts as the Foreign Key (FK) for child table 204 and relates the information of an employee in child table 204 to that in parent table 202.

Child table 206 includes information relating to the departments pertaining to the employees. Child table 206 includes rows 216, 218a, 218b, and 218c.

The ‘Salary’ in parent table 202 is constituted of three components—basic, bonus and overtime. For example, a salary of USD 10000 may be divided as follows: ‘Basic’ USD 5000, ‘Bonus’ USD 3000 and ‘Overtime’ USD 2000. The information relating to these three components is stored in child table 204. Therefore, parent table 202 is related to child table 204 through the column ‘Salary’.

Similarly, ‘Department Code’ in parent table 202 has details regarding the name and the location stored in child table 206. For example, the department code ‘PR’ is associated with the name ‘Production’ and the location ‘California’, the department code ‘QL’ is associated with the name ‘Quality” and the location ‘Arizona’ and the department code ‘MK’ is associated with the name ‘Marketing’ the location ‘Nevada’. Therefore, parent table 202 is related to child table 206 through the column ‘Department Code’. Accordingly, the ‘Department code’ acts as a foreign key for table 202 and a primary key for table 206.

FIG. 3 illustrates a system 300 for protecting data in a database such as a non-production database in accordance with an embodiment of the invention. System 300 includes a data selecting module 302, and a masking module 304. Data selecting module 302 selects data to be protected. The data that is selected for masking is hereinafter referred to as selected data. It may be noted that data selecting module 302 may be operated by a user who decides the configuration and the criteria to select the data. Thereafter, masking module 304 masks the selected data using methods of masking known in the art. In another embodiment, user defined methods of masking may be used for masking the selected data.

Data selecting module 302 selects a first data part and enables the selection of at least one data part related to the first data part upon selection of the first data part. For example, consider dataset 202 for purpose of explanation. Upon selection of a first data part such as column ‘Salary’(shown in FIG. 2), data selecting module 302 enables the selection of at least one related data part such as, for example, the column ‘Basic’ or ‘Bonus’ in related table ‘SAL’.

The first data part and the at least one related data part are hereinafter referred to as the selected data.

Data selecting module 302 is functionally similar to the selecting module of the configuration engine described in commonly owned, co-pending U.S. patent application Ser. No. 11/274,558 entitled, “System and Method for Managing Data in a Database” referenced above.

A brief description of the working of the selecting module is described herein: The selecting module enables creation of a configuration that is created from the datasets in a production database such as production database 102. The configuration includes the datasets linked according to their relational model, i.e. a driving table may be linked to one or more related child tables. Subsequently, at least one criterion may be applied to the configuration. The application of the criterion on the configuration enables selection of a subset of production database 102 that is subsequently stored in test database 104.

Once data selecting module 302 performs the data selection, masking module 304 is activated. Masking module 304 includes a masking rule selecting module 306, a masking previewing module 308, and an assignment module 310. Masking rule selecting module 306 selects a masking rule from a plurality of masking rules. The plurality of masking rules may be stored in a masking rule database. In an embodiment, the masking rule database is a part of the configuration engine and is stored in a server associated with the configuration engine.

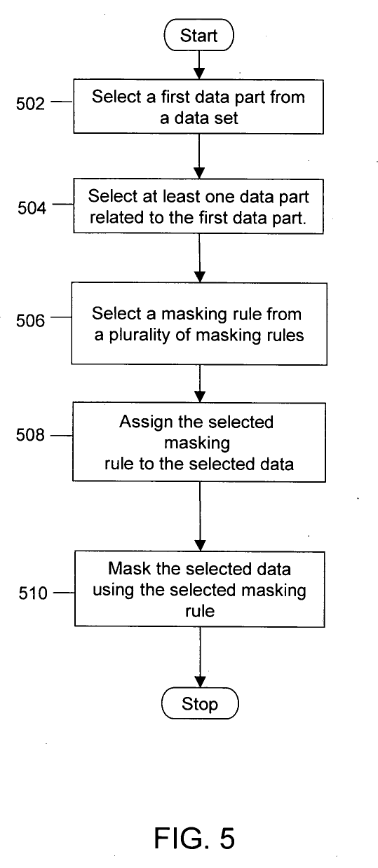

The masking rule is a technique which may use logic or an algorithm to mask the selected data. The types of masking rules that may be applied will be explained in detail with reference to FIG. 5. In accordance with an embodiment, masking rule selecting module 306 allows defining a masking rule. The masking rules defined may be added to the masking rule database.

The selected masking rule is applied on a sample of the selected data by masking previewing module 308. This enables previewing the result of application of a particular masking rule on the sample of the selected data. The previewing of the result assists in selecting a suitable masking rule.

Assignment module 310 assigns the selected masking rule to the selected data. Further, assignment module 310 ensures that the selected masking rule is applied to all the data parts in the selected data simultaneously. For example, a single masking rule may be applied to columns “Salary”, “Basic”, “Bonus” and “Overtime” of database 200.

The selected data after masking may alternatively be referred to as a ‘masked data’

In various embodiments of the invention, system 300 further includes a de-masking module 312. De-masking module 312 de-masks the masked data using an appropriate de-masking rule. It will be apparent to those skilled in the art that the de-masking rule being used for the masked data would correspond to the masking rule applied on the selected data.

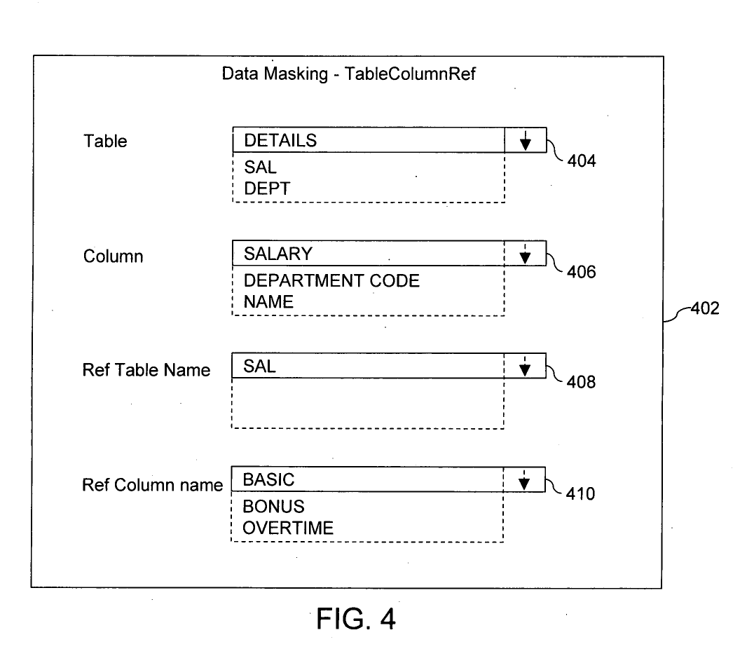

FIG. 4 is an exemplary block diagram of a Graphical User Interface (GUI) screen 402 for selecting data for protection, in accordance with various embodiments of the invention. Screen 402 includes menus 404, 406, 408 and 410. In an embodiment, each of menus 404, 406, 408 and 410 is a drop down menu which enables selection of one element out of a plurality of elements. The element may be a data set (exemplified in the form of table) or a data part (exemplified in the form of a column of a table). It may be noted that the operations conducted on GUI screen 402 may be performed by a user of system 300.

For an exemplary explanation of GUI screen 402, consider database 200. In an embodiment of the invention, menu 404 displays a list of tables present in a non-production database such as a database 200. Accordingly, the list includes tables—‘DETAILS’, ‘SAL’, and ‘DEPT’. In an embodiment, the user selects table ‘DETAILS’ from the list. If then table ‘DETAILS’ is selected, then menu 406 displays a list of the columns of table ‘DETAILS’, including ‘Employee Code’, ‘Name’, ‘Salary’, ‘Department Code’, and ‘Citizen’. In the exemplary embodiment, the user selects column ‘Salary’ from the list of columns. Thereafter, menu 408 displays a list of tables related to table ‘DETAILS’ through column ‘Salary’. Accordingly, the table ‘SAL’ is displayed in menu 408.

In an embodiment, there may be more than one table related to table ‘DETAILS’ through column ‘Salary’. In such a case, menu 408 displays the corresponding list of the plurality of tables. In another embodiment, there may not be any table related to the table ‘DETAILS’. In such a case, menu 408 does not display any list. For example, there are no tables related to the table ‘DETAILS’ through columns ‘Name’ and ‘Citizen’ in database 200.

Thereafter, the columns in table ‘SAL’ that relate to the column, ‘Salary’ are displayed in menu 410. Accordingly, menu 410 displays the following columns—‘Basic’, ‘Bonus’, and ‘Overtime’. In the embodiment of the invention, the column ‘Basic’ is selected. It may be apparent to a person skilled in the art that in order to associate more columns, such as, for example, ‘Bonus’ and ‘Overtime’ in table ‘SAL’ with column ‘Salary’ in table ‘DETAILS’, a similar screen may be generated and a similar method as described above may be performed.

FIG. 5 is a flowchart depicting a method for protecting data in a database, such as a non-production database, in accordance with an embodiment of the invention.

It may be noted that the method steps as described herein may be performed by a user of system 300.

At step 502, a first data part is selected from at least one dataset of the database. Consider for example, test database 104 shown in FIG. 1. Accordingly, a first data part such as data part 110a is selected from data set 106a.

At step 504, at least one data part related to the first data part is selected. The data selection may be carried out by data selecting module 302. Since data parts 110d and 110g are related to data part 110a, either one of them may be selected. In an embodiment, both data parts 110d and 110g are selected. Accordingly, data parts 110a, 110d and 110g together form the selected data.

In accordance with alternate embodiments, the selected data may include data parts that are unrelated. For example, the masked data part may include only data parts 110b and 110c, which may be selected using the method described with reference to FIG. 4.

At step 506, a masking rule is selected out of the plurality of masking rules stored in the masking rule database.

Various techniques may be employed for achieving the masking of the selected data. Some of the techniques that may be employed are as follows:

1. Replacement Technique

This technique involves replacing the letters and special characters in the selected data with random characters (such as ‘X’, ‘*’, ‘#”) and the numeric characters with numbers.

For example, a credit card number: 23A4 56BC 00D9 0EF0 G765 associated with an employee would appear as follows after applying the replacement technique: 99X9 99XX 99X9 9XX9 X999.

2. NULL Technique

This method involves deletion of data part(s) in the selected data and replacing the data parts with NULL values.

3. Substitution Technique

The substitution technique involves replacing the selected data with false data in a random manner. Depending on the substitution algorithm employed, the data to be substituted would need to be pre-populated either in ‘look-up’ tables or drawn from any other similar data source. In an embodiment, the substitute values of a column may be obtained by juggling the values of the column itself. For example, in table 204 (of FIG. 2), the data in columns ‘Basic’, ‘Bonus’ and ‘Overtime’ may be shuffled such that the summation of the three columns do not add up to the salary in table 202.

4. Encryption Technique

The encryption technique involves converting the selected data into special characters so that the selected data is rendered unreadable. In an embodiment, the Data Encryption Standard (DES) algorithm may be selected as the base for encryption.

In an embodiment, the encryption destroys the formatting and overall look of the selected data. For instance, the encrypted selected data may appear as binary data. It would be apparent to a person skilled in the art that suitable decryption algorithms can be tied to the encryption algorithms for reversing the selected data back into its original form.

In accordance with an embodiment of the invention, the result of application of a particular masking rule on a sample of the selected data may be previewed. The previewing assists in selecting an appropriate masking rule. At step 508, the selected masking rule is assigned to the selected data.

At step 510, the selected data (including datasets 110a, 110d and 110g) is masked using the selected masking rule. The association of data parts 110d and 110g with data part 110a ensures that the same masking rule is applied throughout the selected data. The masking therefore protects the selected data.

It may be noted that the selected data may include

The present invention enables masking a first data part and any related data parts to the first data part simultaneously using a single masking rule. The simultaneous masking of all the related data parts ensures that the data parts are masked in an efficient manner. The present invention also enables selective masking of the data parts in datasets. The selective masking of the related data ensures that only the data which is considered confidential and sensitive by a user of the system is masked.

Various embodiments of the invention allow integration of a large number of masking algorithms into a single algorithm repository such as the masking rule database. An algorithm of choice may be selected and applied to the selected data.

Further, a user-friendly GUI is provided that allows simple selection of the selected data to be masked.

The system for masking the selected data, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device, which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A system for protecting data stored in a database, the database comprising a plurality of data sets, each data set comprising a plurality of data parts, at least one of the plurality of data sets being related to at least one of the plurality of the other data sets, the system comprising:
a. a data selecting module for selecting data from the database, the data selecting module enabling the selection of at least one data part upon selection of a first data part, the at least one data part being related to the first data part, the at least one data part and the first data part being in separate datasets; and
b. a masking module for masking the selected data.

2. The system according to claim 1, wherein the masking module comprises:
a. an masking rule selecting module, the masking rule selecting module selecting a masking rule out of a plurality of masking rules being stored in a masking rule database, the masking rule being a technique for encrypting the selected data; and
b. an assignment module, the assignment module assigning the selected masking rule to the selected data.

3. The system according to claim 1, wherein the masking module further comprises a masking previewing module, the masking previewing module being used to view the result of application of the encryption rule on a sample of the selected data.

4. The system according to claim 1 further comprising a de-masking module to de-mask the selected data after the selected data has been masked.

5. The system according to claim 1, wherein the database is a non-production database.

6. A method for protecting data in a database, the database comprising a plurality of data sets, each data set comprising a plurality of data parts, at least one of the plurality of data sets being related to at least one of the plurality of the other data sets, the method comprising the steps of:
a. selecting a first data part from at least one data set, the at least one data set being part of the plurality of datasets;
b. selecting at least one data part from a data set related to the at least one data set, the data set being related to the at least one data set; and
c. masking the first data part and the at least one data part, the at least one data part being related to the first data part.

7. The method according to claim 6, wherein the step of selecting the first data part and the at least one data part is performed using a configuration engine.

8. The method according to claim 6, wherein the step of masking comprises the steps of:
a. selecting a masking rule out of a plurality of masking rules, the plurality of rules being stored in a masking rule database; and
b. assigning the selected masking rule to the first data part and the at least one data part.

9. The method according to claim 6, wherein the step of selecting a masking rule out of the plurality of masking rules comprises the step of previewing the result of application of the masking rule on a sample of a selected data, the selected data being the first data part and the at least one data part.

10. A computer program product for masking data in a database using a configuration engine, the database comprising a plurality of data sets, each data set comprising a plurality of data parts, at least one of the plurality of data sets being related to at least one of the plurality of the rest of data sets, the computer program product comprising a computer readable medium comprising:
a. program instruction means for selecting a first data part from at least one data set, the at least one data set being part of the plurality of datasets;
b. program instruction means for selecting at least one data part from a data set related to the at least one data set, the data set being related to the at least one data set; and
c. program instruction means for masking the first data part and the at least one data part, the at least one data part being related to the first data part.

11. The computer program product according to claim 10, wherein the program instruction means for selecting the first data part and the at least one data part is performed using a configuration engine.

12. The computer program product according to claim 10, wherein the program instruction means for masking the first data part and the at least one data part comprises:
a. program instruction means for selecting a masking rule out of a plurality of masking rules, the plurality of masking rules being stored in a masking rule database; and
b. program instruction means for assigning the selected masking rule to the first data part and the at least one related data part.
